(19) United States
(12) Patent Application Publication
(10) Pub. No.: US 2003/0035289 A1
(43) Pub. Date: Feb. 20, 2003

(54) Colorful decorative light

(76) Inventor: Tsui-Tuan Fan Wong, Hsitzu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/055,469

(22) Filed: Jan. 23, 2002

Related U.S. Application Data
(63) Continuation-in-part of application No. 09/933,251, filed on Aug. 20, 2001.

(51) Int. Cl. F21S 4/00

(52) U.S. Cl. 362/235; 362/242; 362/806

(57) ABSTRACT

A colorful decorative light is disclosed. The colorful light includes a length of flexible core (10) provided with mini-bulbs (12) and wires (14) electrically connecting to the mini-bulbs (12), and a substantially transparent outer covering (30) encasing the core (10). In addition, a colorful and transparent cladding (20) is arranged between the core (10) and the outer covering (30), in order to provide a fancy decoration.

### CROSS REFERENCE

This application is a continuation-in-part of U.S. patent application Ser. No. 09/933,251 ('251), filed on Aug. 20, 2001, by the same applicant of this application. The content of '251 patent application is hereinafter incorporated and taken for reference.

### BACKGROUND OF THE INVENTION

1. Field of the Invention

The present invention relates to a decorative light and, more particularly, to a colorful light which can provide a fancy decoration.

2. Description of Related Art

Decorative lights having a plurality of bulbs arranged in a length of a flexible core are known. In such a light, the flexible core is directly covered with a transparent outer covering that is either colorless or monocolor. The monotony or lack of variety of the decorative light in its color degrades the decoration it may provide.

Therefore, it is an objective of the invention to provide a colorful decorative light to mitigate and/or obviate the aforementioned problem.

### SUMMARY OF THE INVENTION

The object of the present invention is to provide a colorful decorative light which can provide a fancy decoration.

Other objects, advantages and novel features of the invention will become more apparent from the following detailed description when taken in conjunction with the accompanying drawings.

### BRIEF DESCRIPTION OF THE DRAWINGS

FIG. 1 is a fragmentary perspective view of a colorful decorative light in accordance with the present invention;

FIG. 2 is a fragmentary view of an embodiment of the decorative light in FIG. 1 having a series of units;

FIG. 3 is a fragmentary perspective view showing a different embodiment of the colorful decorative light in FIG. 1; and

FIG. 4 is a fragmentary perspective view showing still another embodiment of the colorful decorative light in FIG. 1.

### DETAILED DESCRIPTION OF THE PREFERRED EMBODIMENT

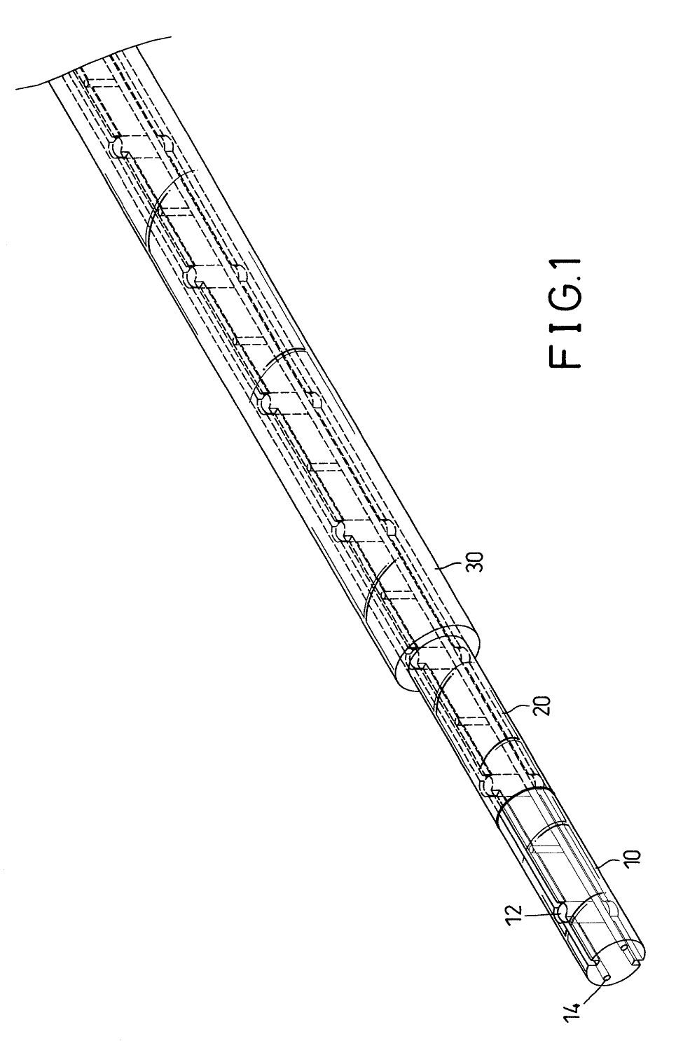

Referring to FIG. 1, a colorful decorative light in accordance with the present invention includes a length of flexible core (10) provided with mini-bulbs (12) and wires (14) electrically connecting the bulbs (12), and a substantially transparent outer covering (30) encasing the core (10).

A transparent and colorful cladding (20) is arranged between the core (10) and the outer covering (30). The cladding (20) may be arranged either in a series of lengths, as illustrated in FIG. 1, which can be of different colors or in spirals which can also be of different colors. The variety of colors, of course, provides the light with an optically attractive property, especially when it is lit.

It is conceivable that the cladding (20) can be made from a variety of materials, such as a coating of color paint, one or more colored bands wound around the core (10), or even a plurality of colored sleeves mounted around the core (10).

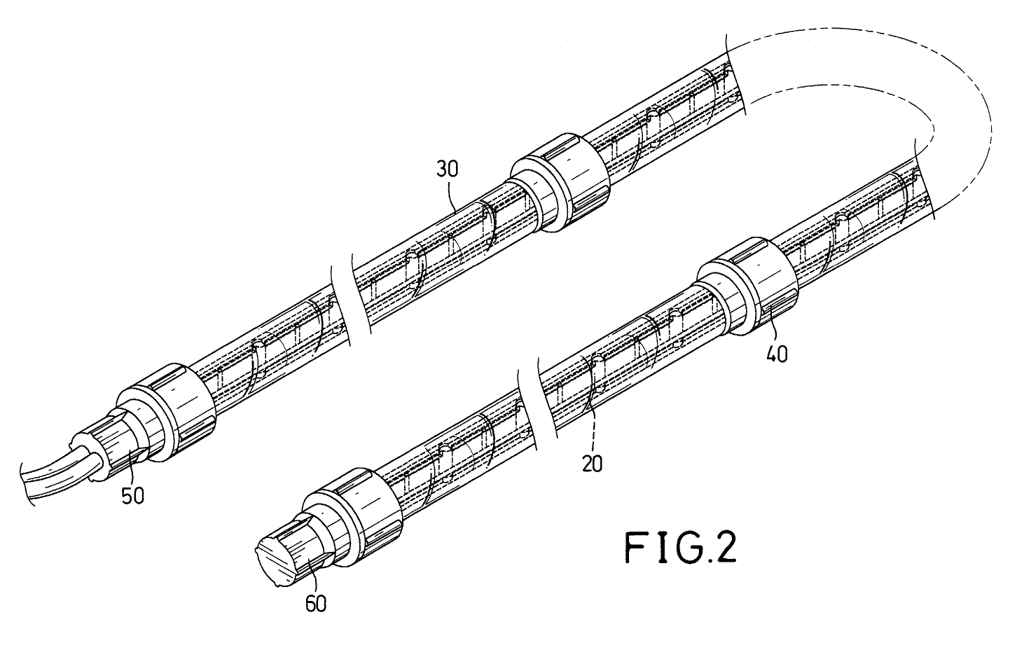

Referring to FIG. 2, there is shown a fragmentary view of an embodiment of the colorful light that has a series of units in quantity N. If each unit here has 3 differently colored areas, the whole light will present a great number of different colors, which, indeed, gives a fancy decoration.

The units can be connected sequentially by a plurality of intermediate connectors (40), with a front connector (50) mounted to the first unit and a back plug (60) mounted to the last unit.

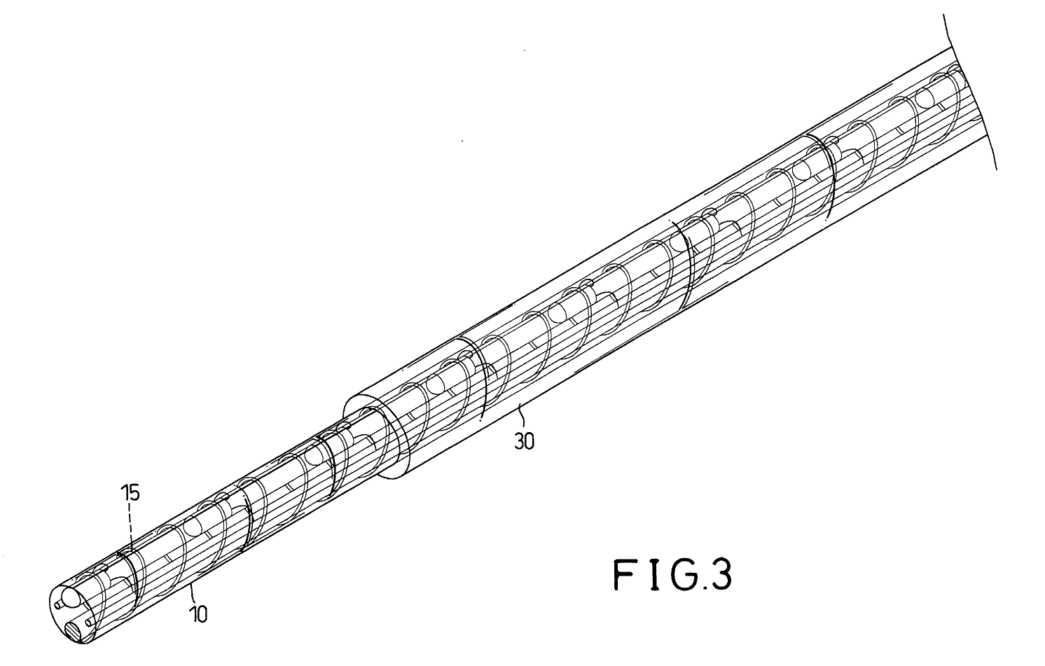

Referring to FIG. 3, in order to further enhance the effect of the present invention, the colorful cladding (20) is omitted. Instead, a colorful strip (15) is formed inside the flexible core (10). The colorful strip (15) is added to the flexible core (10) when the flexible core (10) is extrusion molded. After the flexible core (10) is formed, the outer covering (30) is then extrusion molded around the flexible core (10). The colorful strip (15) is helically displaced inside the flexible core (10) so that the colorful effect is enhanced when the mini-bulbs (12) are lit.

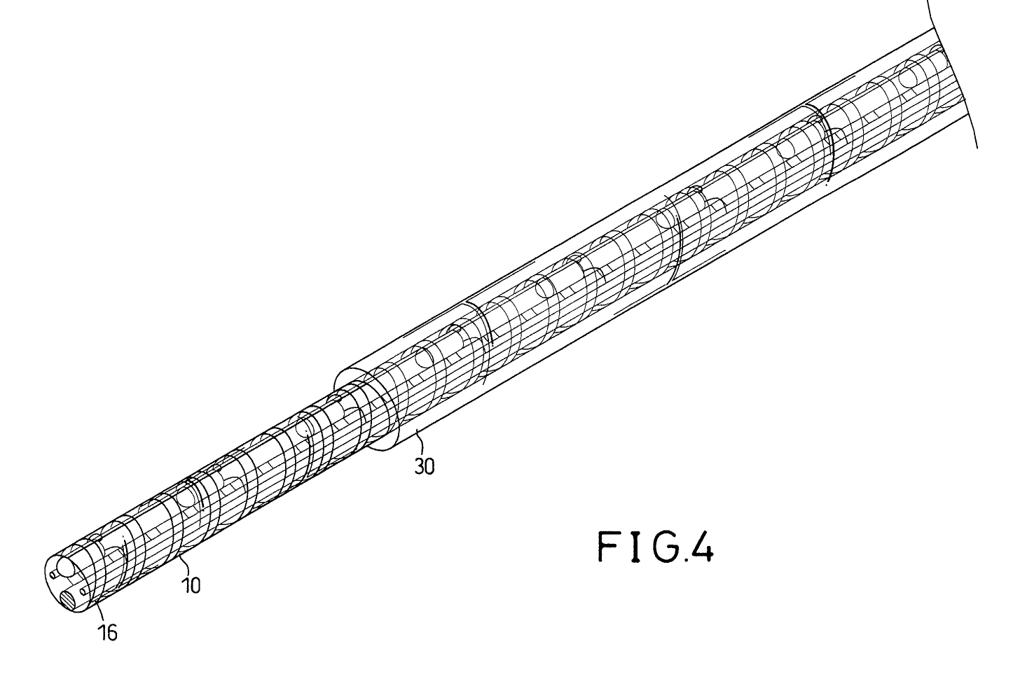

Another approach of achieving the same effect as taught by FIG. 1 is to wrap around the flexible core (10) a colorful band (16). Referring to FIG. 4, then, the outer covering (30) is extrusion molded around the flexible core (10).

A further note is that the mini-bulbs (12) in FIGS. 1 and 2 are located in the flexible core (10) in a direction perpendicular to the longitudinal direction of the flexible core (10) of the decorative light of the invention. However, the mini-bulbs (12) in FIGS. 3 and 4 are located in the flexible core (10) in a direction horizontal to the longitudinal direction of the flexible core (10) of the decorative light of the present invention.

From the above description, it is noted that the invention has the advantage of being colorful and hence provides a fancy decoration.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A colorful decorative light comprising:
a length of flexible core (10) provided with mini-bulbs (12) and wires (14) electrically connecting to said mini-bulbs (12);
a substantially transparent outer covering (30) encasing said core (10); and
a colorful and transparent cladding (20) arranged between said core (10) and said outer covering (30).

2. The colorful decorative light as claimed in claim 1, wherein said cladding (20) is embodied as a coating of color paint.

3. The colorful decorative light as claimed in claim 1, wherein said cladding (20) is embodied as colored band wound around said core (10).

4. The colorful light as claimed in claim 1, wherein said cladding (20) is embodied as a plurality of colored sleeves mounted around said core (10).

5. A colorful decorative light comprising:
a length of flexible core (10) provided with mini-bulbs (12) and wires (14) electrically connecting to said mini-bulbs (12);
a substantially transparent outer covering (30) encasing said core (10); and
a colorful strip spirally mounted inside the flexible core (10).
